(19) United States
(12) Patent Application Publication
(10) Pub. No.: US 2015/0375182 A1
(43) Pub. Date: Dec. 31, 2015

(54) Collider Mixer

(71) Applicant: GSSC, INC., Clearwater, FL (US)

(72) Inventors: Blake K. Travis, II, Clearwater, FL (US); Tom Hedger, Trinity, FL (US)

(73) Assignee: GSSC, INC., Clearwater, FL (US)

(21) Appl. No.: 14/316,856

(22) Filed: Jun. 27, 2014

(51) Int. Cl. B01F 5/06; B01F 3/08; B01F 13/00

(52) U.S. Cl. CPC B01F 5/061; B01F 13/0027; B01F 3/0873; B01F 3/0803; B01F 2215/006

(57) ABSTRACT

A collider mixer includes a collider mixer element of cylindrical shape. Partitions form cylindrical channels around the collider mixer element. An input port is coupled to a first channel and an output port is coupled to a last channel. Exactly one inter-partition passage is formed in each of the partitions and a mixing chamber with a cylindrical inner surface holds the mixer element such that outer edges of the partitions seal against the inner surface of the mixing chamber, forming the channels. Fluids enter the input port and splits. A first portion of the fluids flow one direction through each channel and a remaining second portion of the fluids flow in an opposite direction through the same channel. The first portion of the fluids and the second portion of the fluids meet and collide at the inter-partition passages, then pass through the inter-partition passage to an adjacent channel.

### FIELD

This invention relates to the field of mixing fluids and more particularly to a system for mixing fluids that set quickly.

### BACKGROUND

Many fluids need to be mixed well before applying, for example, when spraying on a surface for rigidity or for affixing the surface to another surface in which the fluids are multiple parts of an adhesive. Many such fluids are very viscous (thick). For example, a resin and a catalyst are often very viscous, especially the resin. Likewise, a typical adhesive and hardener such as a two part epoxy is also viscous. A mix of polyurea and isocyanate as a catalyzer are often mixed before applying.

The properties and applications for such materials and many other fluid materials require that the materials be mixed just before application. For many materials, mixing before application is possible due to both the reaction during mixing and the amount of time before the mixture sets (e.g. hardens). For example, some epoxy adhesives set on the order of one hour after being mixed. Many of these materials are mixed in batches before applying.

The properties and applications for some materials require that the fluids be mixed almost instantaneously before application to the target surface. In some cases, setting completes within several seconds of mixing. If such fluids are mixed in a batch, the batch would set before application is complete. In some cases, the mixing of the fluids causes a reaction as with polyurethane/urea foams (commonly known as polyurethane foam. The reaction of, for example, isocyanates and water forms carbamic acid that quickly decomposes, splitting off carbon dioxide and leaving behind an amine. In such, the carbon dioxide provides the foaming action. If this mixing is performed in a batch, the foam would occur in the mixing vat, requiring large amounts of space to contain the foam.

Some prior spray gun systems mixed two or more fluids within the spray gun just before forcing the combined fluid out of a nozzle. Such in-line mixing works for certain fluids, especially low viscosity fluids that readily mix, perhaps in the nozzle, but mixing some fluids in this manner results in uneven mixing, especially high viscosity fluids, resulting in almost separate streams of each fluid exiting the nozzle and mixing partially at the target surface.

Some prior mixing systems such as disclosed in U.S. Pat. No. 7,744,019 to Merchant, include a turbulent flow chamber of considerable length. These mixers repeatedly split the materials, and then fold the mix onto itself. In U.S. Pat. No. 7,744,019, the spiral mixer is a reversely flighted segmented pattern with each segment being reversely flighted from adjacent segments. This pattern allows homogenous mixing of a catalyst and resin as they pass through a mixing tube. This reference discloses that the tube and spiral mixer are preferably made of an inexpensive plastic so that after spraying, catalyzed resin both can be discarded, as some of the catalyst and resin will set (harden) within the tube and mixer. Due to the length of travel of the fluids, some of the fluids that mix very at an early point in these types of mixers often begin to set before exiting the mixer, causing clogs and wear downstream in the mixer and nozzle.

What is needed is a system that will properly mix two or more fluids in a minimal distance, hence reducing time.

### SUMMARY

In one embodiment, a collider mixer is disclosed including a collider mixer element that has a plurality of partitions. The partitions form channels around the collider mixer element between an input port that is fluidly coupled to a first channel and an output port that is fluidly coupled to a last channel. Inter-partition passages are formed in each of the partitions for passing the fluid from one channel to an adjacent channel. A mixing chamber surrounds the partitions of the collider mixer such that outer edges of the partitions abut inside walls of the mixing chamber, enclosing the channels. Fluids entering the input port split and a first portion of the fluids flow in one direction through each channel and a remaining second portion of the fluids flow in an opposite direction through the channel The first portion of the fluids and the second portion of the fluids meet and collide at the inter-partition passages, where the fluids recombine and pass through the inter-partition passage to an adjacent channel.

In another embodiment, a method of mixing two or more fluids is disclosed including (a) partially pre-mixing the fluids then (b)

splitting the fluids into two separate flows of the fluids, a first flow and a second flow. The first flow is collided with the second flow which is repeated as many times as needed to mix the fluids to the desired level of mixing.

In another embodiment, a collider mixer is disclosed including a collider mixer element having a cylindrical shape and having plurality of cylindrical partitions. The cylindrical partitions form cylindrical channels around the collider mixer element. An input port is fluidly coupled to a first cylindrical channel and an output port is fluidly coupled to a last cylindrical channel. Exactly one inter-partition passage is formed/cut in each of the partitions and a mixing chamber that has a cylindrical inner surface matching an outer cylindrical surface of the cylindrical partitions holds the mixing chamber such that outer edges of the cylindrical partitions seal with the inner surface of the mixing chamber, thereby enclosing the cylindrical channels. Fluids enter the input port and split. A first portion of the fluids flow one direction through each cylindrical channel and a remaining second portion of the fluids flow in an opposite direction through the same cylindrical channel. The first portion of the fluids and the second portion of the fluids meet and collide at the inter-partition passages, where the first portion of the fluids recombine with the second portion of the fluids and then pass through the inter-partition passage to an adjacent cylindrical channel.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of an collider apparatus for mixing with the collider mixing element shown removed from the housing.

FIG. 2 illustrates a perspective view of the collider apparatus for mixing with the collider mixing element shown within the housing.

FIG. 3 illustrates a cutaway view of the collider apparatus for mixing with the collider mixing element shown removed from the housing.

FIG. 4 illustrates a cutaway view of the collider apparatus for mixing with the collider mixing element shown within the housing.

FIG. 5 illustrates a plan view of the collider apparatus for mixing with the collider mixing element shown removed from the housing.

FIG. 6 illustrates a plan view of the collider apparatus for mixing from the exit end.

FIG. 7 illustrates a plan view of the collider apparatus for mixing from the fluid entry end.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this description, the collider mixer apparatus is described mixing two fluids such as a resin and a catalyst or an adhesive and a catalyzer, etc., for example purposes only as it is fully anticipated that any number of fluids are mixed by the collider mixer apparatus having two or more input orifices.

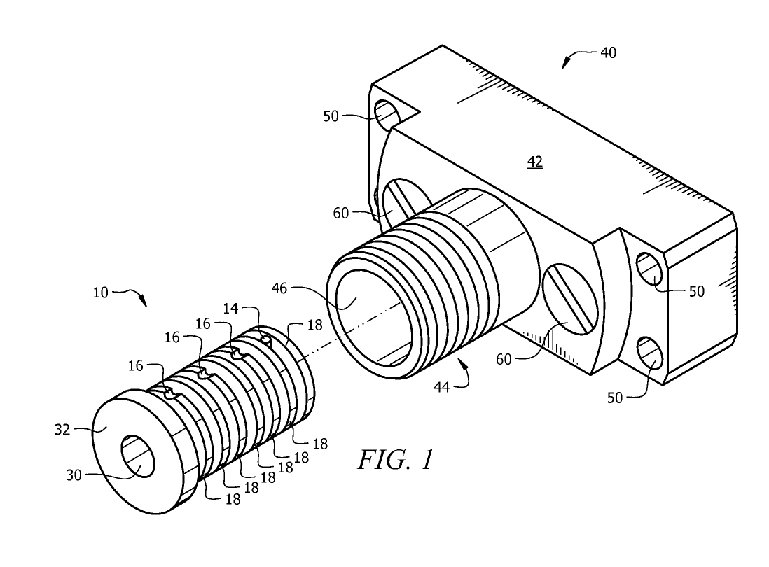

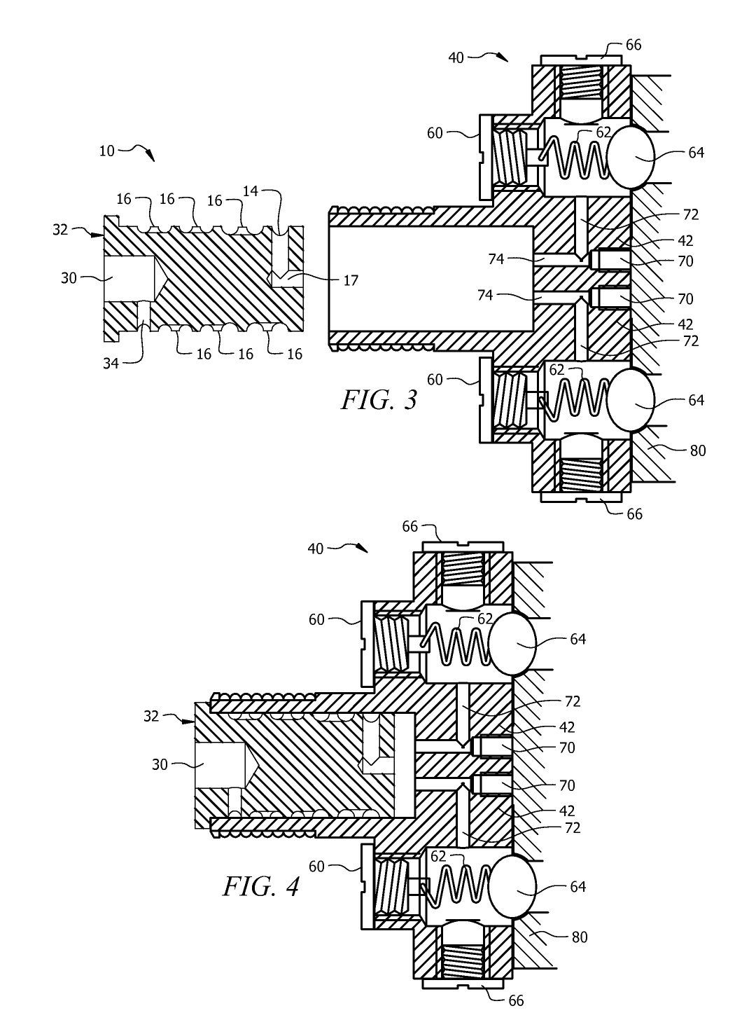

Referring to FIG. 1, a perspective view of a collider apparatus for mixing with the collider mixing element 10 is shown removed from the housing 40. The collider mixing element 10 fits snuggly within the mixing chamber 44 of the housing 40, such that the partitions 18 interface with the inside wall 46 of the mixing chamber 44. In such an arrangement, fluids entering into the collider mixing element 10 through an input orifice 14 are forced to separate and travel in opposing directions in channels formed around the perimeter of the collider mixing element 10 between successive partitions 18 to the opposite side of the collider mixing element 10 where the separated flows of fluids collide, forcing the fluids to comingle and mix, then traveling through the inter-partition passages 16 into an adjacent partition passage 16 between adjacent partitions 18 where the above steps are repeated until the fluids, now being well mixed, exit through an exit orifice 34 (see FIG. 3), through the exit bore 30 and into a downstream device such as a nozzle (not shown) that is mounted over the exit surface 32 and fastened by, for example, a fastener (not shown) threaded to the threads around the outer surface of the mixing chamber 44.

The opposing side of the collider mixing element 10 has similar inter-partition passages 16 so that, on one side of the collider mixing element 10, inter-partition passages 16 permit passage of fluid between odd partitions 18 and on the opposite side of the collider mixing element 10, inter-partition passages 16 permit passage of fluid between even partitions 18. In this way, the combined fluids enter the collider mixing element 10 through an input orifice 14 and approximately half of the fluids go around the collider mixing element 10 in a clockwise direction and the remainder of the fluids go around the collider mixing element 10 in a counterclockwise direction, meeting on the distal opposite side of the collider mixing element 10 where the two flows (clockwise flow and counterclockwise flow) collide and mix. The mixed/blended flows then transition through the inter-partition passage 16 (on the opposite side, not visible in FIG. 1, see FIGS. 3 and 4), again splitting and circumnavigating the collider mixing element 10, etc. The collision between the two flows (clockwise flow and counterclockwise flow) mixes the two or more input materials. In the exemplary collider mixing element 10 shown, the fluids collide seven times before exiting through the exit orifice 34.

Note that any length, dimension, and/or number of partitions 18 are anticipated providing any required number of collisions as to provide the needed degree of mixing. Also, although in the embodiments shown, the inter-partition passages 16 on alternating partitions 18 are located approximately 180 degrees apart around the collider mixing element 10, any arrangement of inter-partition passages 16 is anticipated. For example, it is equally anticipated that the second inter-partition passages 16 is positioned at approximately 150 degrees around the collider mixing element 10. In this way, the fluid traveling in one direction around the collider mixing element 10 must travel further than the fluid traveling in the opposite direction around the collider mixing element 10 and, therefore, different portions of the fluids will mix at the collision.

Also note that, although the spacing between partitions 18 is shown as being the same between all partitions 18, any spacing between partitions 18 is equally anticipated, forming larger or smaller channels between certain partitions 18 affects flow rates and collision actions.

Also note that, although the outer shape of the collider mixer 10 and the inner shape of the mixing chamber 44 are substantially cylindrical, any shape is anticipated.

Holes 50 bored through the base 44 of the housing 40 are provided for attaching to an up-stream device 80 (see FIG. 3) that, for example, controls the flow of the fluids under pressure, etc. Fasteners 60 provide access to check valves 62/64 (see FIGS. 3 and 4).

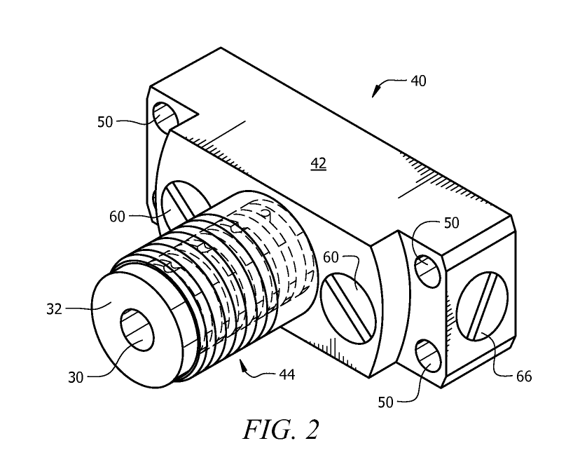

Referring to FIG. 2, a perspective view of the collider apparatus for mixing with the collider mixing element 10 is shown within the housing 40. The inside walls 46 of the mixing chamber 44 prevents a majority of the fluids from passing over the partitions 18, except where the inter-partition passages 16 allow the fluid to transition over the partitions 18, transitioning between adjacent channels. The fasteners 60/66 are explained with FIG. 3.

In use, a down-stream device such as a nozzle is removably affixed over the exit surface 32 by, for example, a threaded fastener that holds the down-stream device (not shown) in contact with the exit surface 32, thereby receiving the mixed fluids from the exit bore 30. For cleaning, the down-stream device is removed and the collider mixing element 10 is removed from the mixing chamber 44, providing access to most surfaces for cleaning, for example, with solvents and air streams.

Referring to FIGS. 3 and 4, a cutaway view of the collider apparatus for mixing in which the collider mixing element 10 shown removed from the housing 44 in FIG. 3, and a cutaway view of the collider apparatus for mixing in which the collider mixing element 10 is shown within the housing 44 in FIG. 4.

In these views, the sequencing of inter-partition passages 16 is clear, showing the upper inter-partition passages 16 on odd number partitions 18 (from the left) and the lower inter-partition passages 16 on even number partitions 18. Again, adjacent inter-partition passages 16 are shown offset from each other by 180 degrees as an example, and any offset is anticipated.

Although two fluids are shown being mixed as an example, any number of fluids is anticipated. The fluids are provided under pressure from an up-stream device 80 such as a dispensing gun or other valve assembly for control of the flow of the fluids. The fluids preferably pass through check valves 60/62/64 to prevent any of the fluids from back-flowing into the up-stream device 80, potentially clogging that device 80. In this example, the check valve comprises a spring 62 that biases a ball 64 against a surface of the up-stream device 80, such that, fluid pressure from the up-stream device 80 works against the spring 62, thereby allowing flow from the up-stream device 80 into the housing 40, while pressure on the fluids within the housing 40 work with the spring 62, preventing flow of fluids from the housing 40 back into the up-stream device 80. Removable fasteners 60 hold the spring 62 in place and are removed for cleaning of the housing 40, springs 62, and balls 64.

Although generally required only for production, cover screws 66 and set screws 70 seal production holes used during manufacture. During manufacturing, in some embodiments, the first input channels 72 are formed by drilling from where the cover screws 66 are shown, before the cover screws 66 are installed. Likewise, the second input channels 74 are formed by drilling from where the set screws 70 are shown, before the set screws 70 are installed.

A first fluid flows from the up-stream device 80 around the upper ball 64, through the upper first channel 72, through the upper second channel 74 and into a space between a back surface of the collider mixing element 10 and an inner-most surface of the mixing chamber 40. A second fluid flows from the up-stream device 80 around the lower ball 64, through the lower first channel 72, through the lower second channel 74 and into the same space between a back surface of the collider mixing element 10 and an inner-most surface of the mixing chamber 40. The first fluid and the second fluid partially mix in the space between a back surface of the collider mixing element 10 and an inner-most surface of the mixing chamber 40 before entering the collider mixing element 10 through a mixer channel 17, then out the input orifice 14, splitting and traveling between the first two partitions 18, etc.

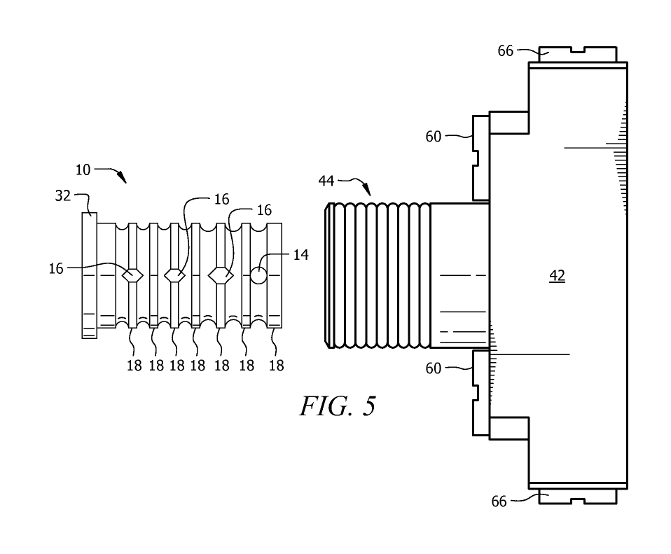

Referring to FIG. 5, a plan view of the collider apparatus for mixing with the collider mixing element 10 is shown removed from the housing 40, as is done for cleaning. The threads on the outside surface of the mixing chamber 44 are shown as an example for attaching a downstream device having mating threads, though any form of attachment is anticipated, with or without threads.

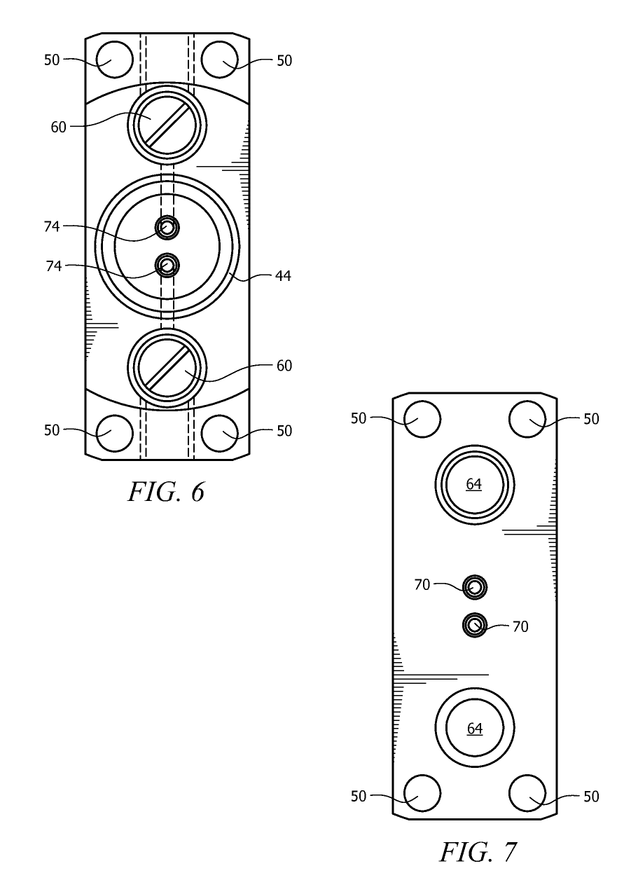

Referring to FIG. 6, a plan view of the collider apparatus for mixing from the downstream device end is shown. The input channels 74 are visible within the mixing chamber 44.

Referring to FIG. 7, a plan view of the collider apparatus for mixing from the upstream device 80 end is shown. The check valve balls 64 and the set screws 70 are visible.

Note that various aspects of the disclosed embodiments, various specific shapes, sizes, and appendages are shown that relate to one specific method of manufacturing the collider mixer, but such disclosure is not provided to limit the claims in any way as other methods of manufacturing are equally anticipated.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A collider mixer comprising:
a collider mixer element having a plurality of partitions, the partitions forming channels around the collider mixer element, an input port fluidly coupled to a first channel of the channels and an output port fluidly coupled to a last channel of the channels;
inter-partition passages formed in each of the partitions; and
a mixing chamber, the collider mixer held within the mixing chamber such that outer edges of the partitions abut inside walls of the mixing chamber, enclosing the channels;
whereas fluids entering the input port split with a first portion of the fluids flowing one direction through each channel and a remaining second portion of the fluids flowing in an opposite direction through the each channel, the first portion of the fluids and the second portion of the fluids meet and collide at the inter-partition passages, where the fluids recombine and pass through the inter-partition passage to an adjacent channel.

2. The collider mixer of claim 1, wherein the inter-partition passages circumnavigate the collider mixer element.

3. The collider mixer of claim 1, wherein the inter-partition passages on each partition are formed at angular offsets to inter-partition passages adjacent partitions.

4. The collider mixer of claim 3, wherein the angular offset is 180 degrees.

5. The collider mixer of claim 3, wherein the angular offset is less than 180 degrees.

6. The collider mixer of claim 1, wherein the fluids are partially premixed before entering the first channel through the input port.

7. The collider mixer of claim 1, wherein the fluids comprise a resin and a catalyst.

8. A method of mixing two or more fluids, the fluids being pressurized, the method comprising:
(a) partially pre-mixing the fluids;
(b) splitting the fluids into two separate flows of the fluids, a first flow and a second flow;
(c) colliding the first flow with the second flow; and
(d) repeating steps (b) through (d) as many times as needed to mix the fluids to the desired level of mixing.

9. The method of claim 8, wherein the first flow travels counter clockwise through a channel and the second flow travels clockwise through the channel.

10. The method of claim 9, wherein after colliding, the fluids transition into an adjacent channel or into an exit orifice.

11. The method of claim 8, wherein the first fluid is a catalyst and the second fluid is a resin.

12. The method of claim 8, wherein the steps of splitting and colliding are performed in the channel, the channel being formed between two partitions of a collider mixer element, the collider mixer element held within a mixing chamber such that outer edges of the partitions abut inside walls of the mixing chamber, enclosing the channels.

13. The method of claim 12, wherein the partitions include inter-partition passages, whereas after the step of colliding, the fluids cross over to an adjacent channels through one of the inter-partition passages located on one of the partitions separating the channel with the adjacent channel.

14. A collider mixer comprising:
a collider mixer element having a cylindrical shape and having plurality of cylindrical partitions, the cylindrical partitions form cylindrical channels around the collider mixer element, an input port fluidly coupled to a first cylindrical channel of the cylindrical channels and an output port fluidly coupled to a last cylindrical channel of the cylindrical channels;
one inter-partition passages formed in each of the partitions; and
a mixing chamber having a cylindrical inner surface matching an outer cylindrical surface of the cylindrical partitions, the collider mixer held within the mixing chamber such that outer edges of the cylindrical partitions abut the inner surface of the mixing chamber, enclosing the cylindrical channels;
whereas fluids enters the input port and splits such that a first portion of the fluids flow one direction through each cylindrical channel and a remaining second portion of the fluids flow in an opposite direction through the each cylindrical channel, the first portion of the fluids and the second portion of the fluids meet, collide, and recombine at the inter-partition passages, then the fluids pass through the inter-partition passage to an adjacent cylindrical channel.

15. The collider mixer of claim 14, wherein the inter-partition passages circumnavigate the collider mixer element.

16. The collider mixer of claim 14, wherein the inter-partition passages on each cylindrical partition are formed at angular offsets to inter-partition passages adjacent partitions.

17. The collider mixer of claim 16, wherein the angular offset is 180 degrees.

18. The collider mixer of claim 16, wherein the angular offset is less than 180 degrees.

19. The collider mixer of claim 14, wherein the fluids are partially premixed before entering the first cylindrical channel through the input port.

20. The collider mixer of claim 14, wherein the fluids comprise a resin and a catalyst.
